(19) United States
(12) Patent Application Publication
(10) Pub. No.: US 2005/0068256 A1
(43) Pub. Date: Mar. 31, 2005

(54) Helmet with a tire status apparatus

(75) Inventors: Sheng-Hsiung Lin, Kaohsiung (TW); Chang-Hung Lai, Kaohsiung Hsien (TW)

Correspondence Address: Dennison, Schultz, Dougherty & MacDonald;Suite 105, 1727 King Street, Alexandria, VA, 22314, US

(73) Assignee: LITE-ON AUTOMOTIVE CORP.

(21) Appl. No.: 10/736,590

(22) Filed: Dec. 17, 2003

(30) Foreign Application Priority Data
Sep. 26, 2003 (TW) 092126593

(51) Int. Cl. G09G 5/00

(52) U.S. Cl. 345/8

(57) ABSTRACT

A helmet having detecting tire status capability has a body with a face guard, a controller, a projector and a power circuit. The controller receives current tire status signals from tire status sensors in the wheels and further displays the current tire status value on the face guard and detects whether the tire status signals are abnormal. If a tire status signal is abnormal, the controller drives the projector to display a warning word or symbol on the face guard. The rider sees real-time information about the wheel so the rider can handle developing situations with the wheels.

### BACKGROUND OF THE INVENTION

1. Field of the Invention

The present invention relates to a helmet for a motorcycle rider, and more particularly to a helmet that has an apparatus to present tire status and warn a motorcycle rider of abnormal tire parameters.

2. Description of Related Art

Motorcycle riders wear helmets to protect their heads in the event of an accident. Unlike automobiles, motorcycles do not have many safety devices such as tire pressure monitoring systems. Properly inflated tires are essential to the safety operation of vehicles including motorcycles so drivers or riders must learn to notice the tire status and understand its significance.

Vehicles with a tire pressure monitoring system have tire pressure gauges mounted respectively in the wheels to sense the current tire pressure and send a signal with the current tire pressure to a main controller in the vehicle, which presents the current tire pressure to the driver. Thus, the driver is made aware the situation of the wheel and further notices whether the wheels need to be replaced or maintained. However, motorcycle riders do not have the ability to constantly monitor pressure tire to or determine when the wheels on the motorcycle are unsafe.

To overcome the shortcomings, the present invention provides a helmet having a tire status capability to mitigate or obviate the aforementioned problems.

### SUMMARY OF THE INVENTION

The main objective of the present invention is to provide a helmet that receives various tire parameters from two wheels of a motorcycle and projects the tire parameters so a rider wearing the helmet can see the current parameters.

Another objective of the present invention is to provide a helmet that determines when tire parameters are abnormal and presents an abnormal symbol to warn a rider wearing the helmet that the tire is unsafe.

Another objective of the present invention is to provide a helmet that has a power-saving function. The objective is achieved by mounting at least one sensor switch in the helmet to detect when a rider is wearing the helmet. If the rider is wearing the helmet, the helmet enables the tire status capability. Therefore, the helmet saves power when the rider is not wearing the helmet.

Other objectives, advantages and novel features of the invention will become more apparent from the following detailed description when taken in conjunction with the accompanying drawings.

### BRIEF DESCRIPTION OF THE DRAWINGS

FIG. 1 is a cross sectional side plan view of a helmet in accordance with the present invention;

FIG. 2 is a front plan view of the helmet in FIG. 1;

FIG. 3 is a functional block diagram of a controller mounted in the helmet in FIG. 1 communicating with two tire status sensors;

FIG. 4 is an operational side plan view of a person wearing the helmet in FIG. 1 and riding in a motorcycle with tire status sensors;

FIG. 5 is a flow chart of a procedure to determine abnormal tire status in accordance with the present invention;

FIG. 6 is a flow chart of a procedure to set a new pressure in the controller in accordance with the present invention; and

FIG. 7 is an operational block diagram of a method in accordance with the present invention of operating the helmet in FIG. 1.

### DETAILED DESCRIPTION OF THE PREFERRED EMBODIMENT

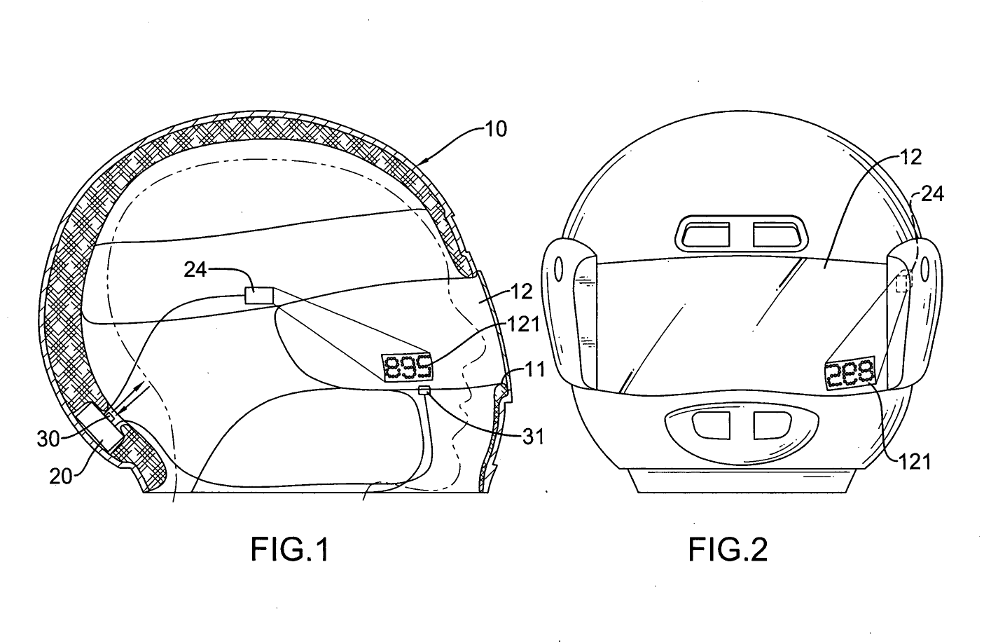

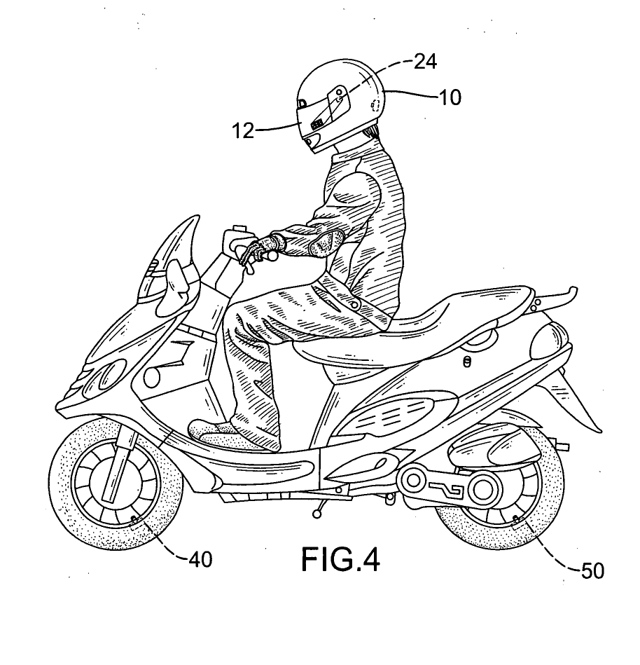

With reference to FIGS. 1 and 4, a helmet in accordance with the present invention communicates with a front tire status sensor (40) and a rear tire status sensor (50) mounted respectively in a front wheel and a rear wheel of a motorcycle. Each tire status sensor (40, 50) detects multiple tire parameters, formats the tire parameters into tire status information signals and sends tire status information signals to the helmet. The helmet receives the tire status information signals and displays the tire status information to the rider. The tire status parameters include tire pressure, tire temperature, tire air leakage, etc.

With further reference to FIG. 1, the helmet has a body (10) with an opening (11), a face guard (12), a projector (24) and a controller (20).

With further reference to FIG. 2, the face guard (12) has an inside surface (not numbered), pivots relative to the body (10) and covers the opening (11). The inside surface has a display area (121). The display area (121) is not directly in front of the rider's eyes so the display area (121) does not obstruct the rider's vision. The display area (121) is coated with a reflective layer (not shown) so an image projected on the display area (121) is clearer.

The projector (12) is mounted in the body (10), faces toward the opening (11) and projects an image toward the opening (11). When the face guard (12) is closed and covers the opening (11), the image will be displayed on the display area (121).

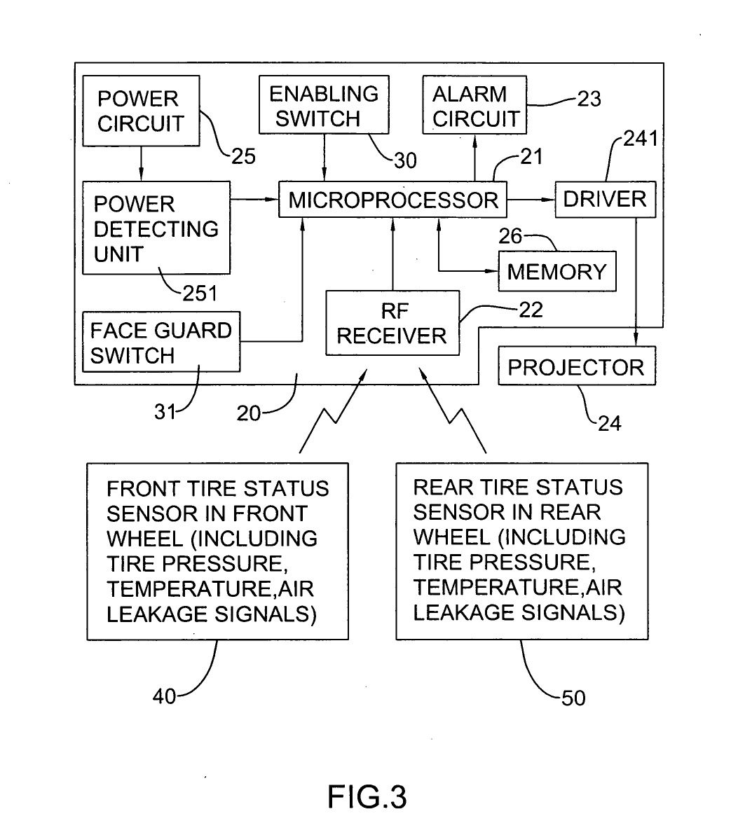

With further reference to FIG. 3, the controller (20) controls and drives the projector (24), receives the tire status signals from the two tire status sensors (40, 50), sends the tire status information to the projector (24) that displays the tire status on the face guard (12) and may optionally detect abnormal tire conditions and present a warning to the person wearing the helmet. The controller (20) comprises a microprocessor (21), an RF receiver (22), an optional alarm circuit (23), a power circuit (25), a power detecting unit (251), a video driver (241), memory (26), an enabling switch (30) and a face guard sensor (31).

The microprocessor (21) receives the tire status signals through the RF receiver (22). The microprocessor (21) is connected to the projector (24) through the video driver (241) and is further connected to the alarm circuit (23), the memory (26). The power circuit (25) provides the power to the forgoing circuits. The power detecting unit (251), which is connected between the microprocessor (21) and the power circuit (25), responses the voltage changes of the power circuit (25) to the microprocessor (21). The microprocessor (21) obtains the current voltage through the power detecting unit (251) and determines whether the power circuit (25) outputs enough voltage or not. If the microprocessor (21) determines the power circuit in low voltage situation and then drives the alarm circuit (23) to warn the rider. The power detecting unit (251) could be an analog to digital converter (ADC) or a comparator. The analog to digital converter is integrated with the microprocessor (21).

Each tire status sensor (40, 50) generates a unique code so the microprocessor (21) recognizes the source of a specific tire status signal. For example, when the front tire status detector (40) transmits the current tire pressure signals to the controller (21), the microprocessor (21) obtains the current tire pressure of the front wheel and drives the projector (24) to display the current pressure on the face guard (12). The rider wearing the helmet can read the pressure on the face guard (12).

The enabling switch (30) is connected to the microprocessor (21) and allows the microprocessor (21) to start, prevents the microprocessor (21) from starting or shuts down the microprocessor (21). The enabling switch (30) is mounted on an appropriate position in the body (10) to sense when a person is wearing the helmet. The enabling switch (30) may be a photocoupler. The photocoupler changes output signal when the helmet is placed on a person's head. Thus, the microprocessor (21) may commence operation when the enabling switch (30) indicates that the rider is wearing the helmet.

The face guard sensor (31) is mounted on an edge of the opening (11) to detect when the face guard (12) covers completely the opening (11). Therefore, the enabling switch (30) and face guard sensor (31) may be photocouplers, mechanical switches, pressure switches, etc. or a combination of the foregoing.

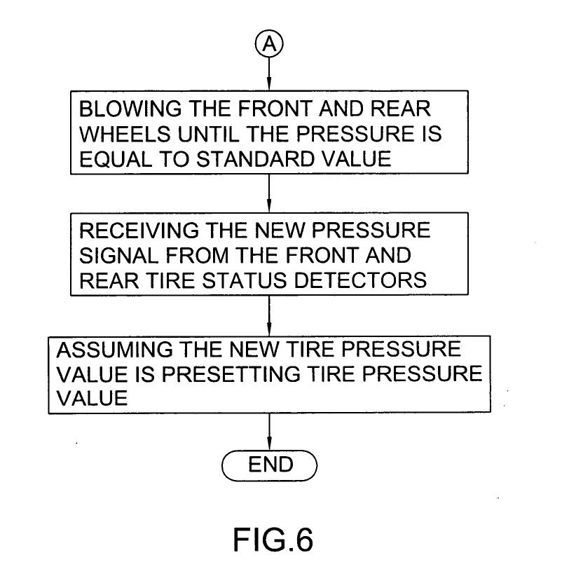

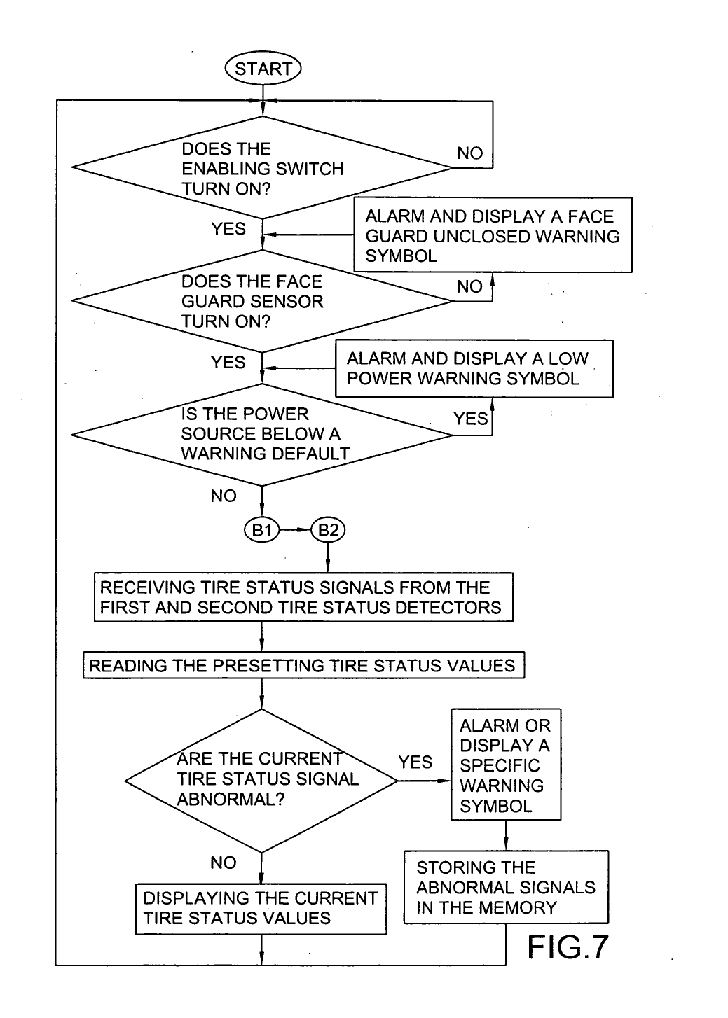

With reference to FIG. 7, the microprocessor (10) executes a procedure to receive and display tire status signals and a procedure to determine and display abnormal tire status. The microprocessor stores preset tire parameters in memory. With reference to FIG. 6, for example, presetting a tire pressure value is accomplished using the following steps: (a) inflating the front and rear wheels until the tire pressure value is equal to a standard value; (b) receiving the new tire pressure value through tire status sensors; and (c) assigning the new tire pressure value as a preset tire pressure value.

With reference to FIG. 7, the procedure to receive and display tire status signals is composed of the following acts
(a) Detecting whether the enabling switch is turned on. If the enabling switch is turned on, the next step executes. If the enabling switch turns off, the enabling switch is queried until the enabling switch turns on.
(b) detecting whether the face guard sensor switch turns on? If the face guard sensor switch turns on executing the next step; if the face guard sensor turns off, alarming or display a face guard unclosed warning symbol on the face guard to warn the rider the face guard does not covered the opening completely and keep detecting the face guard sensor switch until the face guard sensor switch turns on;
(c) detecting whether the power circuit is in low power state? If yes, alarming or display low power warning symbol on the face guard to warn the rider the power is not enough; if no, executing the next step;
(d) receiving the tire status signals from the front and rear tire status sensors;
(e) reading presetting tire status values corresponding to the tire status signals produced by FIG. 6;
(f) executing the determining abnormal tire status signal means; and
(g) determining whether the tire status signals are abnormal? If yes, alarming or display alarming symbols to the face guard and storing the abnormal tire status signals in the memory; if not, display the current tire status values on the face guard.

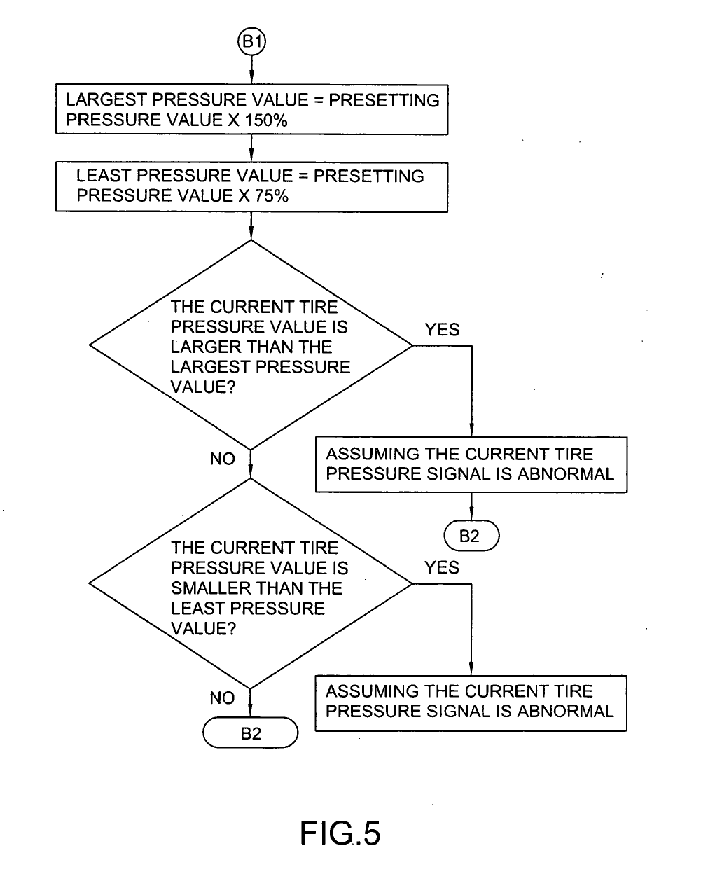

With reference to FIG. 5, the determining abnormal tire status signal means is composed the step of:
(a) calculating a largest pressure value which is equal to the presetting pressure value multiplied x %; wherein the x could be a 150
(b) calculating a least pressure value which is equal to the presetting pressure value multiplied y % which is smaller than x %, wherein the y could be a 75;
(c) comparing the current tire pressure signal with the largest pressure value to determine whether the current tire pressure signal is larger than the largest pressure value; if yes, the current tire pressure signal is abnormal; if not, executing the next step;
(d) comparing the current tire pressure signal with the least pressure value to determine whether the current tire pressure signal is less than the least pressure value; if yes, the current tire pressure signal is abnormal; if not, executing the next step; and
(e) assuming the current tire pressure signal being normal.

Based on the forgoing description, the present invention provides rider useful information about the wheels during riding the motorcycle. The present invention has lots of advantages as follow:
1. Better safety. The controller displays the current tire status values on the face guard so the ride can understand the information about the front and rear wheels. In addition, the display area is not on the line of the vision so the display area does not effect the rider to ride the motorcycle.
2. Saves power. The controller will be in sleeping mode when the enabling switch does not turn on so the controller can save power when the helmet is not worn on the rider.
3. Alarm function. The controller is connected to the alarm circuit and drives the alarm circuit in hard conditions such as low power, the abnormal tire status signal, the face guard covered the opening incompletely.
4. Display function. The controller drivers the projector to display the information related to the current tire status signal, specific alarming symbol etc. to the face guard.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A helmet having detecting tire status capability, comprising a body with an opening;
a face guard connected pivotally to the body to cover the opening;
a controller in the body linked to at least one tire status detector in at least one wheel wherein the controller receives at least one tire status signal from the at least one tire status detector;
a projector mounted in the body and faced to the opening, wherein the projector is connected to the controller; and
a power circuit is connected to the controller and the projector to supply power.

2. The helmet as claimed in claim 1, wherein the controller comprises:
a microprocessor connected to an external memory;
an RF receiver received the tire status signal from the at least one tire status detector and connected to the microprocessor, wherein the RF receiver outputs the tire status signal to the microprocessor;
an alarm circuit connected to the microprocessor; and
a driver connected between the microprocessor and the projector.

3. The helmet as claimed as claim 2, wherein the controller further comprises an enabling switch mounted in the body and connected to the microprocessor to detect whether a rider worn the helmet.

4. The helmet as claimed as claim 2, wherein the controller further comprises a face guard sensor switch mounted on the opening and connected to the microprocessor to detect whether the face guard covers completely.

5. The helmet as claimed as claim 3, wherein the controller further comprises a face guard sensor switch mounted on the opening and connected to the microprocessor to detect whether the face guard covers completely.

6. The helmet as claimed as claim 2, wherein the controller further comprises a power detecting unit connected between the microprocessor and the power circuit.

7. The helmet as claimed as claim 6, wherein the power detecting unit is an analog to digital converter (ADC).

8. The helmet as claimed as claim 6, wherein the power detecting unit is a comparator.

9. The helmet as claimed as claim 7, wherein the microprocessor comprises has a receiving tire status signal means and a determining abnormal tire status signal means.

10. The helmet as claimed as claim 9, wherein the receiving tire status signal means comprises steps of
(a) detecting whether the enabling switch turns on, wherein if the enabling switch turns on executing the next step and if the enabling turns off, detecting the enabling switch until the enabling switch turns on;
(b) detecting whether the face guard sensor switch turns on, wherein if the face guard sensor switch turns on, executing the next step and if the face guard sensor turns off, alarming or display specific alarm symbol and keep detecting the face guard sensor switch until the face guard sensor switch turns on;
(c) detecting whether the power circuit is in low power state, wherein if yes alarming or display specific alarm symbol and if not, executing the next step;
(d) receiving the tire status signals from the front and rear tire status sensors;
(e) reading at least one preset tire parameter corresponding to the at least one tire status signal;
(f) executing the determining abnormal tire status signal means; and
(g) determining whether the at least one tire status signal is abnormal, wherein if yes, alarming or display alarming symbols and storing the abnormal tire status signals in the memory and if not, display the current tire status values on the face guard.

11. The helmet as claimed as claim 9, wherein the determining abnormal tire status signal means comprises steps of
(a) calculating a largest pressure value which is equal to the presetting pressure value multiplied x %;
(b) calculating a least pressure value which is equal to the presetting pressure value multiplied y %, wherein the x is larger than y;
(c) comparing the current tire pressure signal with the largest pressure value to determine whether the current tire pressure signal is larger than the largest pressure value; if yes, the current tire pressure signal is abnormal; if not, executing the next step;
(d) comparing the current tire pressure signal with the least pressure value to determine whether the current tire pressure signal is less than the least pressure value, wherein if yes, the current tire pressure signal is abnormal and if not, executing the next step; and
(e) the current tire pressure signal is normal.

12. The helmet as claimed as claim 10, wherein the determining abnormal tire status signal means comprises steps of
(a) calculating a largest pressure value which is equal to the presetting pressure value multiplied x %;
(b) calculating a least pressure value which is equal to the presetting pressure value multiplied y %, wherein the x is larger than y;
(c) comparing the current tire pressure signal with the largest pressure value to determine whether the current tire pressure signal is larger than the largest pressure value; if yes, the current tire pressure signal is abnormal; if not, executing the next step;
(d) comparing the current tire pressure signal with the least pressure value to determine whether the current tire pressure signal is less than the least pressure value, wherein if yes, the current tire pressure signal is abnormal and if not, executing the next step; and
(e) the current tire pressure signal is normal.

13. The helmet as claimed as claim 5, wherein the enabling switch and the face guard sensor are photocouplers.

14. The helmet as claimed as claim 5, wherein the enabling switch and the face guard sensor are mechanical switches

15. The helmet as claimed as claim 5, wherein the enabling switch and the face guard sensor are pressure switches.
